(19) United States
(12) Patent Application Publication
(10) Pub. No.: US 2007/0255673 A1
(43) Pub. Date: Nov. 1, 2007

(54) METHOD FOR JUDGING STANDARDIZATION ORDER OF WORKPIECES

(75) Inventors: Ping Chen, Shenzhen (CN); Lei Li, Shenzhen (CN); Wen-Quan Xu, Shenzhen (CN); Zhi Cheng, Shenzhen (CN); Chang-Fa Sun, Shenzhen (CN); Qian Chen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); Sutech Trading Limited, Tortola (VG)

(21) Appl. No.: 11/614,013

(22) Filed: Dec. 20, 2006

(30) Foreign Application Priority Data
Apr. 28, 2006 (CN) 200610060523.0

(51) Int. Cl. G06F 15/00

(52) U.S. Cl. 706/62

(57) ABSTRACT

A method for judging standardization order of workpieces includes steps as follows: sampling different types of workpieces, and recording parameters of the samples; transforming the parameters of the respective samples into a plurality of respective standardization grades S for evaluating standardization order of the workpieces; and arranging a standardization order of the workpieces according to their respective standardization grades S.

### BACKGROUND OF THE INVENTION

1. Field of the Invention

The present invention relates to a method for judging standardization order of workpieces and, more particularly, to a method for judging standardization order of workpieces in large quantities and variety of types.

2. Description of Related Art

Standardization of many kinds of workpieces is needed in production of mechanisms. For improving producing efficiency and reducing cost, many parameters of the workpieces are reviewed, and, thus, the order in which workpieces are standardized requires evaluation. For example, if a kind of workpiece is more widely used than other workpieces, prioritizing standardization of this kind of workpiece can increase efficiency; if a kind of workpiece is more expensive than other workpieces, prioritizing standardization of this kind of workpiece can reduce cost.

However, a method for quickly and conveniently deciding the order in which standardization of workpieces takes place is lacking at present. Generally experienced engineers determine the order of standardization of workpieces in a large number or many kinds. These engineers mainly determine standardization order of workpieces using their experience. When the workpieces are of many different kinds and/or of a large quantity, determining a standardization order of the workpieces is likely to be affected by subjective causes, such as carelessness or disagreement between engineers. Thus, a preferred standardization order of the workpieces is difficult to determine.

Therefore, a new judging method for standardizing the order of workpieces is desired in order to overcome the above-described shortcomings.

### SUMMARY OF THE INVENTION

In one preferred embodiment, a method for judging standardization order of workpieces includes steps as follows: sampling a plurality of different types of workpieces, and recording parameters associated with the respective kinds of workpieces sampled; transforming the parameters into a standardization grade S for evaluating standardization order of the workpieces; and arranging a standardization order of the workpieces, according to their standardization grade S.

Other advantages and novel features will become more apparent from the following detailed description when taken in conjunction with the accompanying drawings.

### BRIEF DESCRIPTION OF THE DRAWING

FIG. 1 is a flow chart of a judging method, in accordance with a preferred embodiment.

### DETAILED DESCRIPTION OF THE INVENTION

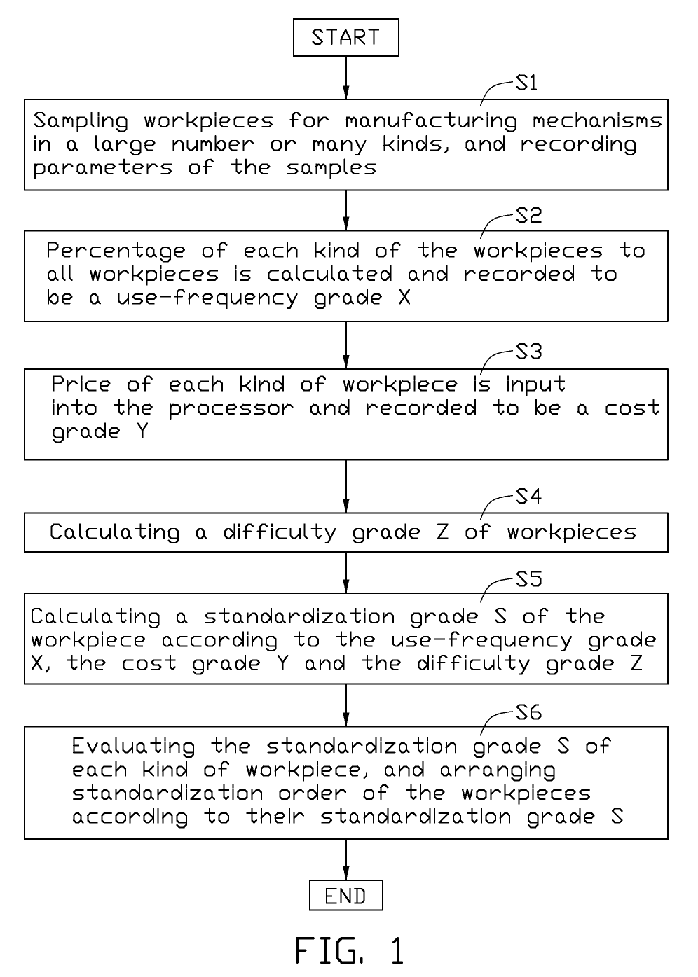

Referring now to the drawing in detail, FIG. 1 shows a judging method, in accordance with a preferred embodiment. The method uses statistics to analyze parameters of workpieces and assign a grade to each workpiece, and, thus, a preferred standardization order of the workpieces is arranged, according to grades of the workpieces. The method includes a series of steps.

Workpieces for manufacturing mechanisms of a large quantity or of many types are sampled, and the parameters of the samples are thereby recorded, as per Step S1. The parameters mainly include, for example, frequency of use of the workpieces, cost of the workpieces, standardization difficulty of the workpieces, etc. These parameters are transformed into a standardization grade S for evaluating standardization order of the workpieces. Standardization grade S is usefully calculated according to a use-frequency grade X, a cost grade Y, and a difficulty grade Z.

The use-frequency grade X of the workpieces is represented by a percentage of the total number of workpieces, constituted by each kind of the workpieces. Therefore, number of each kind of workpieces is input into a processor, such as a computer or a memory chip, and a percentage of workpieces formed by each kind is calculated and recorded as the use-frequency grade X, as per Step S2.

The cost grade Y of the workpieces is represented by a price of the workpieces. The price of each kind of workpiece is input into the processor and is recorded as the cost grade Y (Step S3).

Calculating difficulty grade Z of workpieces (Step S4). The difficulty grade Z represents a standardization difficulty of the workpiece. The lower the standardization difficulty of a kind of workpiece, the higher the difficulty grade Z of this kind of workpiece is assigned. The difficulty grade Z for a standardization difficulty of given workpiece or group of workpieces is calculated by evaluating any of a variety of characteristics, such as shape, size, particular surface features, and apertures, etc., of each kind of workpiece, and transforming these characteristics into the difficulty grade Z. Each kind of configuration characteristic is represented by the difficulty grade Z calculated, according to these steps, as follows:

Firstly, shape of the workpiece is reviewed to evaluate a shape grade A. A workpiece having a more regular shape has less standardization difficulty and a higher standardization grade. For example, the shape grade A of a regular cuboid (i.e., approximately cube) workpiece is 1.0; the shape grade A of a cuboid workpiece that includes a L-shaped gap is 0.7; the shape grade A of a cuboid workpiece that includes a U-shaped gap is 0.5; the shape grade A of a cuboid workpiece that includes a L-shaped gap and a U-shaped gap is 0.7*0.5=0.35; and the rest may be deduced by analogy. In this way, the shape grade A of each workpiece can be calculated according to its configuration characteristics.

Secondly, a precision of the workpiece is reviewed to evaluate a precision grade B thereof. A workpiece requiring a higher level of precision has greater standardization difficulty and therefore a lower standardization grade. Precision can be evaluated according to nominal size of the workpiece. A workpiece having a nominal size to decimal places requires a higher level of precision and lower precision grade B. For example, the precision grade B of a workpiece having an integer-scale size is 1.0; the precision grade B of a workpiece having a size requiring accuracy to one decimal place is 0.5; and the precision grade B of a workpiece having a size requiring accuracy to two decimal places is 0.1. If a workpiece has n different kinds of accuracy requirements, a size accuracy N₁ of the workpiece corresponds to a precision grade B₁, a size accuracy N₂ of the workpiece corresponds to a precision grade B₂, a size accuracy N₃ of the workpiece corresponds to a precision grade B₃, and the rest may be deduced by analogy. For example, a size accuracy Nₙ of the workpiece corresponds to a precision grade Bₙ. The precision grade B is a triple of an average of the precision grades from B₁ to Bₙ. That is to say, the formula for calculating the precision grade B of the workpiece is B=(B₁+B₂+B₃+ . . . +Bₙ)*3/N. Additionally, according to different demands of standardization, the coefficient 3 of the formula can be replaced by other constants.

Thirdly, apertures formed in the workpiece are reviewed to evaluate an aperture grade C. The more apertures a workpiece has, the higher its standardization difficulty and the lower its assigned standardization grade. For example, the aperture grade C of a workpiece having three or less than three apertures is 1.0; the aperture grade C of a workpiece having N (N is larger than three) apertures is 3/N. Additionally, according to different demands of standardization, the coefficient 3 can be replaced by other constants.

Fourthly, reviewing special configuration formed in the workpiece and evaluate a correcting coefficient F. Specifically the more special configurations a workpiece has, the larger the correcting coefficient F. For example, the correcting coefficient F of a workpiece having a simple configuration (i.e., one with plain faces in all three-dimensions) is 0.9; the correcting coefficient F of a workpiece having a surface variance of less than 20 mm² is 0.1; the correcting coefficient F of a workpiece having a surface variance of more than 20 mm² and less than 120 mm² is 0.2; the correcting coefficient F of a workpiece having a overflow larger than 120 mm² is 0.3; and the rest may be deduced by analogy.

After evaluating the shape grade A, the precision grade B, the aperture grade C, and the correcting coefficient F, the difficulty grade Z can be calculated. The formula for calculating the difficulty grade Z is Z=(A+B+C)*(1−F). In this way, the processor can calculate the difficulty grade Z of workpieces after the configuration information of the workpieces and a calculating program are input into the processor.

Calculating the standardization grade S of the workpiece according to the use-frequency grade X, the cost grade Y and the difficulty grade Z is illustrated as Step S5. The formula for calculating the standardization grade S is S=XYZ.

The standardization grade S of each kind/type of workpiece is evaluated, and the respective standardization grades S of the workpieces are arranged into a standardization order, as provided in Step S6. A workpiece having a higher standardization grade S is standardized before those with lower standardization grades. In this way, workpieces requiring the most urgent standardization and workpieces that are easiest to standardize are given priority. Accordingly, standardization efficiency is improved, and standardization cost is decreased.

Understandably, the order of the Steps S2, S3 and S4 can be changed, with the standardization grade S of each kind of workpiece remaining unchanged by the order in which Steps S2-S4 are performed. Additionally, as the standardization grade S is located in a range that can be recorded and compared, the formula for calculating the standardization grade S can also be S=MXYZ. In this case, M is a constant with the order of standardization remaining unchanged. The judging method can also be made into a computer program and input into a processor, thus allowing the processor to automatically judge a standardization order of workpieces.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A method for judging a standardization order of workpieces, the method comprising steps as follows:
sampling a plurality of kinds of workpieces, and recording parameters associated with the respective kinds of workpieces sampled;
transforming the parameters associated with each respective kind of workpieces into a standardization grade S for each respective kind of workpieces and thereby achieve a plurality of the standardization grades S, the standardization grades S being adapted for evaluating a standardization order of the workpieces; and
arranging a standardization order of the workpieces according to the respective standardization grade S associated with a given kind of workpieces.

2. The method as claimed in claim 1, wherein the parameters include a frequency of use of the workpieces, a cost of the workpieces, and a standardization difficulty of the workpieces.

3. The method as claimed in claim 1, wherein the standardization grade S is calculated according to a use-frequency grade X, a cost grade Y and a difficulty grade Z, and the formula for calculating the standardization grade S is one of S=XYZ and S=MXYZ, where M is a constant.

4. The method as claimed in claim 3, wherein the use-frequency grade X is represented by a percentage representing a proportion of total number of workpieces constituted by each kind of workpiece.

5. The method as claimed in claim 3, wherein the cost grade Y is represented by price of the workpieces.

6. The method as claimed in claim 3, wherein the difficulty grade Z is represented by standardization difficulty of the workpiece and calculated according to a shape grade A, a precision grade B, an aperture grade C and a correcting coefficient F, the formula for calculating the difficulty grade Z being Z=(A+B+C)*(1−F).

7. The method as claimed in claim 6, wherein the shape grade A is calculated according to configuration characteristics of each workpiece.

8. The method as claimed in claim 6, wherein the precision grade B is calculated according to an accuracy required in manufacturing each kind of workpiece.

9. The method as claimed in claim 6, wherein the aperture grade C is calculated according to a number of apertures formed in each workpiece.

10. The method as claimed in claim 6, wherein the correcting coefficient F is calculated according to a proportion of each workpiece comprising special configurations.

11. The method as claimed in claim 10, wherein the special configurations are chosen from the group consisting of overflows and three-dimensional configurations.

12. The method as claimed in claim 1, wherein a workpiece having a higher standardization grade S is given a higher priority.
